(19) United States
(12) Patent Application Publication
(10) Pub. No.: US 2026/0357374 A1
(43) Pub. Date: Nov. 12, 2026

(54) METHOD FOR SYNCHRONOUSLY EXTRACTING LITHIUM AND BORON RESOURCES IN BORON-RICH LITHIUM-CONTAINING SYSTEM

(71) Applicant: East China University Of Science And Technology, Shanghai (CN)

(72) Inventors: Sen Lin, Shanghai (CN); Yanan Pan, Shanghai (CN); Yihong Guo, Shanghai (CN); Jianguo Yu, Shanghai (CN)

(21) Appl. No.: 19/125,552

(22) PCT Filed: Feb. 17, 2023
(86) PCT No.: PCT/CN2023/076724

§ 371 Date: Apr. 29, 2025

(30) Foreign Application Priority Data
Nov. 22, 2022 (CN) 202211467312.4

(51) Int. Cl. C22B 7/00; C01B 35/02; C22B 26/12

(52) U.S. Cl. CPC C22B 7/005; C01B 35/023; C22B 26/12

(57) ABSTRACT

A method for synchronously extracting lithium and boron resources in a boron-rich lithium-containing system comprising: S1. filling Li/Al-LDHs as an adsorbent into an adsorption device to form an adsorption bed, pumping a boron-rich lithium-containing adsorption liquid from a lower end of the adsorption device, passing the boron-rich lithium-containing adsorption liquid through the adsorption bed, and then flowing the boron-rich lithium-containing adsorption liquid out from an upper end of the adsorption device; S2. washing the adsorption bed with water from the upper end of the adsorption device after adsorption; S3: pumping a boron desorbing liquid from the lower end of the adsorption device, passing the boron desorbing liquid through the adsorption bed, and collecting an effluent at the upper end of the adsorption device; and S4. pumping a lithium desorbing liquid from the lower end of the adsorption device, passing the lithium desorbing liquid through the adsorption bed, and collecting an effluent at the upper end of the adsorption device. Alternatively, S3 could be performed after S4.

### TECHNICAL FIELD

The present invention relates to the technical field of resource recovery, and in particular to a method for synchronously extracting lithium and boron resources in a boron-rich lithium-containing system.

### BACKGROUND

In recent years, with the rapid development of lithium battery industry, lithium resources are considered to be a foundation for the new energy industry. Similarly, boron and compounds thereof play an important role in the development of chemical industry, metallurgy, agriculture, medicine and other industries. The constant widening of application areas of lithium and boron has brought about a rapid increase in the demand for lithium and boron resources in the market. In the long run, it will be of great significance to improve the ability to develop lithium and boron resources synchronously to fill the gaps in the supply chain. Lithium and boron resources are mostly present in industrial wastewater, groundwater and salt lake brine together, such as wastewater discharged by the nuclear industry, geothermal water and hot spring water. The contents of lithium and boron are relatively high in these systems, and they are important resources with economic value.

In the existing extraction technologies, the industrial methods for extracting lithium include chemical precipitation, gradient membrane coupling, solvent extraction, and adsorption-membrane series process, etc. The technologies for extracting boron mainly include acidification crystallization, precipitation, flotation, adsorption, solvent extraction and other methods. The methods for synchronous extraction of lithium and boron resources mainly include double adsorption method, and method of separating lithium by precipitation and then extracting boron. Most of the combinations of these methods have long process time and low efficiency. It is a hot topic in the research to synchronously separate lithium and boron by one method, for example, by using an adsorbent with good adsorption performance for both lithium and boron.

### SUMMARY

In view of the above technical problem, the present invention provides a method for synchronously extracting lithium and boron resources, in which an aluminum salt adsorbent (Li/Al-LDHs) is used as a raw material for synchronous extraction of lithium and boron resources, and lithium and boron in a boron-rich lithium-containing system are co-adsorbed, and then desorbed stepwise, thus achieving the purpose of simultaneously recovering the two resources.

The metal-layered double hydroxide (LDH) has great potential in ion adsorption and extraction due to interlayer ion exchange function and large specific surface area. The lithium/aluminum-layered double hydroxide (Li/Al-LDHs), having a chemical expression of LiCl·mAl(OH)₃·nH₂O, where m is 2 to 10 and n is 0.5 to 10, has proved to have high adsorption selectivity, high adsorption capacity, and good cycle stability.

In the present invention, Li/Al-LDHs is used as an adsorbent. Based on the principle that lithium ions can be adsorbed onto or desorbed from the sheet and B(OH)₄⁻ can be exchanged with interlayer anions and thus adsorbed or desorbed, lithium and boron resources in the boron-rich lithium-containing system are synchronously adsorbed and extracted, and then the adsorbed lithium and boron elements are desorbed by a desorption process of boron first and then lithium (B—Li) or lithium first and then boron (Li—B), to achieve good desorption and extraction effects.

Specifically, a first aspect of the present invention provides a method for synchronously extracting lithium and boron resources in a boron-rich lithium-containing system (boron first and then lithium (B—Li route)), comprising the following steps:
S1. filling Li/Al-LDHs as an adsorbent into an adsorption device to form an adsorption bed, pumping a boron-rich lithium-containing adsorption liquid from a lower end of the adsorption device, passing the boron-rich lithium-containing adsorption liquid through the adsorption bed, and then flowing the boron-rich lithium-containing adsorption liquid out from an upper end of the adsorption device;
S2. washing the adsorption bed with water from the upper end of the adsorption device after adsorption;
S3: pumping a boron desorbing liquid from the lower end of the adsorption device, passing the boron desorbing liquid through the adsorption bed, and collecting an effluent at the upper end of the adsorption device; and
S4. pumping a lithium desorbing liquid from the lower end of the adsorption device, passing the lithium desorbing liquid through the adsorption bed, and collecting an effluent at the upper end of the adsorption device.

A second aspect of the present invention provides a method for synchronously extracting lithium and boron resources in a boron-rich lithium-containing system (lithium first and then boron (Li—B route)), comprising the following steps:
S1. filling Li/Al-LDHs as an adsorbent into an adsorption device to form an adsorption bed, pumping a boron-rich lithium-containing adsorption liquid from a lower end of the adsorption device, passing the boron-rich lithium-containing adsorption liquid through the adsorption bed, and then flowing the boron-rich lithium-containing adsorption liquid out from an upper end of the adsorption device;
S2. washing the adsorption bed with water from the upper end of the adsorption device after adsorption;
S3: pumping a lithium desorbing liquid from the lower end of the adsorption device, passing the lithium desorbing liquid through the adsorption bed, and collecting an effluent at the upper end of the adsorption device; and
S4. pumping a boron desorbing liquid from the lower end of the adsorption device, passing the boron desorbing liquid through the adsorption bed, and collecting an effluent at the upper end of the adsorption device.

In Step S1 in the present invention, the boron-rich lithium-containing adsorption liquid may be various types of liquid containing both boron and lithium, such as industrial wastewater, groundwater, salt lake brine and the like. For example, salt lake brine generally contains elements such as calcium, magnesium, boron, and lithium, and relatively mature and perfect processes for removing calcium and magnesium are available. The brine from which calcium and magnesium are removed mainly contains boron and lithium elements, which can be synchronously adsorbed and extracted by the method of the present invention. There are no particular requirements on the boron content and lithium content in the boron-rich lithium-containing adsorption liquid of the present invention. The boron content is preferably 1 to 5 g/L, such as 1 g/L, 2 g/L, 3 g/L, 4 g/L, 5g/L, or any between these values. The lithium content is preferably 200 to 500 ppm, such as 200 ppm, 250 ppm, 300 ppm, 350 ppm, 400 ppm, 450 ppm, 500 ppm, or any between these values. In addition, the boron-rich lithium-containing adsorption liquid may be a high-salt system or a low-salt system, and the salt concentration is preferably 0.1 M to 5 M, such as 0.1 M, 0.2 M, 0.4 M, 0.5 M, 0.8 M, 1.0 M, 1.5 M, 2.0 M, 2.5 M, 3.0 M, 3.5 M, 4.0 M, 4.5 M, 5.0 M, or any between these values.

In Step S1 in the present invention, the adsorption device may be various types of adsorbers, such as a resin adsorption column, a fixed bed adsorber. In a preferred embodiment, the adsorption device is a fixed bed adsorber, in which the adsorption bed is 60 cm in height, 2.1 cm in diameter and about 207 mL in volume, and the feed flow rate of the boron-rich lithium-containing adsorption liquid is 1 to 4 BV/h, such as 1 BV/h, 2 BV/h, 3 BV/h, and 4 BV/h.

In Step S2 in the present invention, the adsorption bed is washed with water after adsorption to remove the residual adsorption liquid in the bed. Preferably, deionized water at 0 °C is used for washing, and the performance of the adsorbent can be stabilized at the same time. The volume of deionized water is preferably 1 to 5 times the volume of the adsorption bed, and more preferably 2 times the volume of the adsorption bed. The flow rate is preferably 5.5 to 50 mL/min.

In the present invention, the boron desorbing liquid has a chloride ion concentration of 2 to 5 M and a lithium ion concentration of 0 to 200 ppm. The desorbing liquid is designed based on the principle that the interlayer borate ions in the adsorbent can be replaced with Cl⁻, and NaCl is generally used. The concentration of chloride ion should be as high as possible, so that the extraction efficiency and performance for boron are better. It is demonstrated by previous experiments that it can achieve a good desorption effect when Cl⁻ concentration is 2 to 5 M.

A purpose of the present invention is to maximize the recovery of boron and lithium ions in separate stages. For this purpose, it is necessary to inhibit the desorption of the other ion when one ion is extracted in each desorption stage. Therefore, in the present invention, an amount of a lithium salt can be added in the boron desorbing liquid, to inhibit the desorption of lithium ions.

In addition, the boron desorbing liquid needs to be acidic. When the pH is acidic, boron exists in the form of boric acid, which form is beneficial to boron desorption. Preferably, the pH of the boron desorbing liquid is 2.5 to 6, such as 2.5, 3, 4, 5, and 6, etc. When the pH is greater than 2.5, the structural stability of the adsorbent can be ensured. More preferably, the pH of the boron desorbing liquid is 4.0.

The boron desorbing liquid is prepared by adding sodium chloride into deionized water, then mixing by ultrasonic, adding a small amount of lithium chloride as required, and adjusting the pH of the solution to be acidic, to obtain the desorbing liquid.

In the present invention, the desorption time with the boron desorbing liquid cannot be too long. A too long desorption time may lead to excessive desorption of lithium (lithium is also present in the adsorbent, resulting in the destruction of the adsorbent itself). Preferably, the desorption time with the boron desorbing liquid is 180 min.

In the present invention, the lithium desorbing liquid has a lithium ion concentration of 50 to 500 ppm. When lithium ions are desorbed, deionized water can be used for direct desorption. However, to protect the adsorbent from destruction (to prevent lithium in the adsorbent itself from being desorbed), it is preferable to use a low-concentration lithium solution, which can achieve the function of desorbing lithium while protecting the adsorbent. The lithium desorbing liquid needs to be basic. Because in the stage of lithium desorption, to maximize the recovery of lithium, the desorption of boron needs to be inhibited. When the pH is basic, boron exists in the form of borate, which form is not beneficial to the desorption of boron, so as to achieve good desorption of lithium and inhibit the desorption of boron at the same time. The pH of the lithium desorbing liquid is preferably 9 to 13, such as 9, 10, 11, 12, and 13, and more preferably 12.

In the present invention, the temperature of the desorbing liquid in the lithium desorption stage needs to be controlled to protect the stability of the adsorbent bed, and prevent excessive desorption of lithium. Preferably, the temperature of the lithium desorbing liquid is 40 °C.

In the present invention, the lithium desorbing liquid is prepared by adding a small amount of lithium chloride into deionized water, mixing by ultrasonic, and adjusting the pH of the solution to be basic, to obtain the desorbing liquid.

Further, the time for desorbing lithium with the lithium desorbing liquid is 180 min.

In the present invention, the flow rate in the whole desorption process may be preferably controlled to be 2 to 6 BV/h, and more preferably 3 BV/h.

Compared with the prior art, the present invention achieves the following beneficial effects:
1. After adsorption in a low-salt system by the synchronous extraction method of the present invention, the adsorbed amounts of lithium and boron can reach 40 mg and 600 mg, respectively, and the adsorption effects are excellent. After desorption and extraction according to the B—Li route, 100% of boron can be extracted after desorption for 180 min, and the lithium desorption and extraction rate reaches 72.03% after desorption for 360 min. In the Li—B route, lithium can be completely extracted after desorption for about 30 min, and the boron extraction rate is as high as 76.89% after desorption for 360 min.
2. After adsorption in a high-salt system by the synchronous extraction method of the present invention, the adsorption effects for lithium and boron change slightly, but can reach 80 mg and 400 mg, respectively, and the effects are excellent. In the B—Li route, lithium can be completely extracted after desorption for 260 min, and the extraction rate of boron is as high as 91.88% after desorption for 6 hrs. In the Li—B route, lithium and boron can be completely extracted after desorption for 60 min and 360 min, respectively.
3. In the present invention, lithium and boron in the boron-rich lithium-containing system are co-adsorbed by using an aluminum salt adsorbent (Li/Al-LDHs), and then synchronously desorbed and extracted by using two different desorption routes, to achieve the purpose of simultaneously recovering the two resources. The method is simple to operate, and the main raw materials are cheap and readily available. Efficient synchronous extraction is achieved to obtain a higher economic benefit and widen the application of the aluminum salt adsorbent (Li/Al-LDHs), thus having great significance.

### BRIEF DESCRIPTION OF THE DRAWINGS

FIG. 1 shows the technical solutions in Examples 1 to 4;

FIG. 2 shows an absorption breakthrough curve (a) and a desorption recovery curve (b) of lithium and boron in a boron first and then lithium process in a desorption experiment with a low-salt adsorption system in Example 1;

FIG. 3 shows an absorption breakthrough curve (a) and a desorption recovery curve (b) of lithium and boron in a lithium first and then boron process in a desorption experiment with a low-salt adsorption system in Example 2;

FIG. 4 shows an absorption breakthrough curve (a) and a desorption recovery curve (b) of lithium and boron in a boron first and then lithium process in a desorption experiment with a high-salt adsorption system in Example 3; and

FIG. 5 shows an absorption breakthrough curve (a) and a desorption recovery curve (b) of lithium and boron in a lithium first and then boron process in a desorption experiment with a high-salt adsorption system in Example 4.

### DETAILED DESCRIPTION

The present invention will be further described below with reference to the accompanying drawings and specific examples, so that those skilled in the art would better understand and implement the present invention. However, the present invention is not limited to the examples. Unless otherwise defined, all technical and scientific terms used herein have the same meaning as commonly understood by those skilled in the art. The terms used in the description of the present invention are for the purpose of describing particular embodiments only and are not intended to limit the present invention. The term “and/or” as used herein includes any and all combinations of one or more of the listed items.

The methods used in examples below are all conventional methods, unless otherwise stated. The materials and reagents used are all commercially available, unless otherwise stated.

In the following examples, the boron-rich lithium-containing system is prepared in the laboratory, and the main components are sodium tetraborate decahydrate, sodium chloride, and lithium chloride.

### Example 1

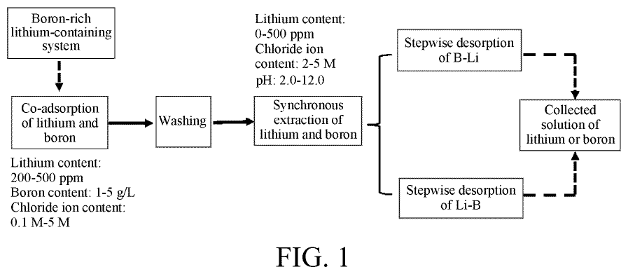

For a low-salt lithium-boron adsorption system, an experimental idea of boron first and then lithium was used in this example, and the whole operation was as follows.
(1) Adsorption of low-salt system: A low-salt adsorption liquid with a chloride ion concentration of 0.5M, a boron ion concentration of 1500 ppm and a lithium ion concentration of 300 ppm was used. According to the process shown in FIG. 1, the liquid was flowed into from the bottom of a bed and flowed out from the top and sampled, and the adsorption process was continued for 2 hrs. The whole process was carried out at room temperature, and 48.175 mg of lithium ions and 620.25 mg of boron ions were co-adsorbed.
(2) Water washing: The bed was washed with deionized water at 0 °C by feeding into the bed from the top according to the process shown in FIG. 1, where 2 bed volumes of deionized water was fed in total.
(3) Whole desorption process of boron first and then lithium: According to the process shown in FIG. 1, the desorbing liquids were introduced from the bottom, and the desorption was carried out in two stages. In the first stage, a desorbing liquid with 5 M NaCl and 100 ppm Li+, pH 4.0, was used. Considering further lithium recovery in a subsequent stage, lithium was contained in the desorbing liquid in this stage to inhibit the desorption of lithium ions. The feed flow rate was 3 BV/h, and the feed time was 180 min in total. The effluent samples were taken at different feed times. In the second stage, a lithium chloride solution with 100 ppm Li⁺, pH 11.0, was used as a desorbing liquid. The temperature of the desorption process in this stage was controlled to be 40 °C and the feed time was 180 min in total. The samples were taken at different times.

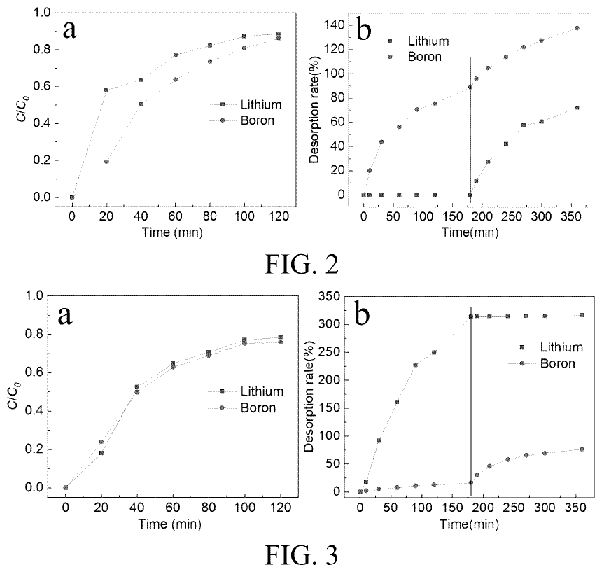

The desorption recovery rate of the whole desorption process is shown in FIG. 2. In the first desorption stage, boron ions are desorbed and recovered in a large quantity, and the desorption rate is as high as 88.99% after desorption for 180 min. In the second stage for lithium recovery, the final desorption rate of lithium ions is as high as 72.03%. In the whole process, boron ions can be completely desorbed at a desorption time of about 180 min. In theory, lithium can also be completely desorbed with the increase of the desorption time.

### Example 2

For a low-salt lithium-boron adsorption system, an experimental idea of lithium first and then boron was used in this example, and the whole operation was as follows.
(1) Adsorption of low-salt system: A low-salt adsorption liquid with a chloride ion concentration of 0.5M, a boron ion concentration of 1500 ppm and a lithium ion concentration of 300 ppm was used. According to the process shown in FIG. 1, the liquid was flowed into from the bottom of a bed and flowed out from the top and sampled, and the adsorption process was continued for 2 hrs. The whole process was carried out at room temperature, and 81.85 mg of lithium ions and 651.2 mg of boron ions were co-adsorbed.
(2) Water washing: The bed was washed with deionized water at 0 °C by feeding into the bed from the top according to the process shown in FIG. 1, where 2 bed volumes of deionized water was fed in total.
(3) Whole desorption process of lithium first and then boron: According to the process shown in FIG. 1, the desorbing liquids were introduced from the bottom, and the desorption was carried out in two stages. In the first stage, as much lithium ions as possible were desorbed (the desorption of boron was inhibited). A lithium chloride solution with 100 ppm Li⁺, pH 12.0, was used as a desorbing liquid. The feed flow rate was 3 BV/h, and the temperature was controlled to be 40 °C at the same time. In the second stage, boron was desorbed (the desorption of lithium was inhibited). A 5M NaCl solution, pH 4.0, was used. It should be noted that Li⁺ is not contained in the high Cl-solution. The feed flow rate and mode remained unchanged, the feed time was 180 min in total, and samples were taken at different times.

After the overall analysis of the desorption recovery rate in the two stages, the results are shown in FIG. 3. In the first desorption stage, 100% desorption of lithium ions can be achieved after desorption for about 30 min, and the expected purpose is achieved. In the second stage, lithium ions are substantially not desorbed, and boron ions are desorbed in a large quantity in this stage. When the desorption time reaches 360 min, the boron desorption and extraction rate is as high as 76.89%, which means that boron ions can be completely desorbed with the increase of the desorption time.

### Example 3

For a high-salt lithium-boron adsorption system, an experimental idea of boron first and then lithium was used in this example, and the whole operation was as follows.
(1) Adsorption of high-salt system: A low-salt adsorption liquid with a chloride ion concentration of 2.0M, a boron ion concentration of 1500 ppm and a lithium ion concentration of 300 ppm was used. According to the process shown in FIG. 1, the liquid was flowed into from the bottom of a bed and flowed out from the top and sampled, and the adsorption process was continued for 2 hrs. The whole process was carried out at room temperature, and 82.975 mg of lithium ions and 436.875 mg of boron ions were co-adsorbed.
(2) Water washing: The bed was washed with deionized water at 0 °C by feeding into the bed from the top according to the process shown in FIG. 1, where 2 bed volumes of deionized water was fed in total.
(3) Whole desorption process of boron first and then lithium: According to the process shown in FIG. 1, the desorbing liquids were introduced from the bottom, and the desorption was carried out in two stages. In the first stage, a desorbing liquid with 5 M NaCl and 100 ppm Li⁺, pH 4.0, was used. Considering further lithium recovery in a subsequent stage, lithium was contained in the desorbing liquid in this stage to inhibit the desorption of lithium ions. The feed flow rate was 3 BV/h, and the feed time was 180 min in total. The effluent samples were taken at different feed times. In the second stage, a lithium chloride solution with 100 ppm Li⁺, pH 12.0, was used as a desorbing liquid. The temperature of the desorption process in this stage was controlled to be 40 °C and the feed time was 180 min in total. The samples were taken at different times.

The desorption recovery rate of the whole desorption process is shown in FIG. 4. In the first stage, boron is desorbed in a large quantity in this stage, and the desorption rate is as high as 91.88% after desorption for 180 min. In the second stage, lithium is mainly desorbed at this time. When the desorption time reaches 250 min, lithium is completely desorbed, and boron remains in the process of desorption. In the whole process, boron can also be theoretically completely desorbed with the increase of the desorption time.

### Example 4

For a high-salt lithium-boron adsorption system, an experimental idea of lithium first and then boron was used, and the whole operation was as follows.
(1) Adsorption of high-salt system: A low-salt adsorption liquid with a chloride ion concentration of 2.0 M, a boron ion concentration of 1500 ppm and a lithium ion concentration of 300 ppm was used. According to the process shown in FIG. 1, the liquid was flowed into from the bottom of a bed and flowed out from the top and sampled, and the adsorption process was continued for 2 hrs. The whole process was carried out at room temperature, and 85.23 mg of lithium ions and 478.98 mg of boron ions were co-adsorbed.
(2) Washing: The bed was washed with deionized water at 0 °C by feeding into the bed from the top according to the process shown in FIG. 1, where 2 bed volumes of deionized water was fed in total.
(3) Whole desorption process of lithium first and then boron: According to the process shown in FIG. 1, the desorbing liquids were introduced from the bottom, and the desorption was carried out in two stages. In the first stage, as much lithium ions as possible were desorbed (the desorption of boron was inhibited). A lithium chloride solution with 100 ppm Li⁺, pH 12.0, was used as a desorbing liquid. The feed flow rate was 3 BV/h, and the temperature was controlled to be 40 °C at the same time. In the second stage, boron was desorbed (the desorption of lithium was inhibited). A 5M NaCl solution, pH 4.0, was used. It should be noted that Li⁺ was not contained in the high Cl-solution. The feed flow rate and mode remained unchanged, the feed time was 180 min in total, and samples were taken at different times.

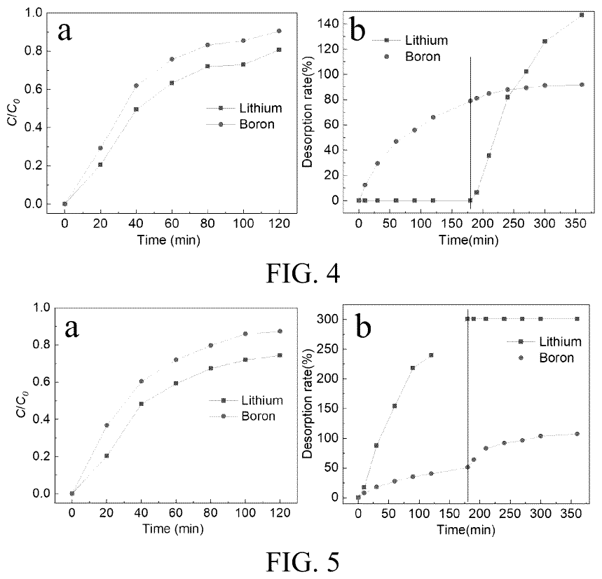

After the overall analysis of the desorption recovery rate in the two stages, the results are shown in FIG. 5. In the first stage for desorbing lithium, 100% lithium desorption can be achieved after desorption for about 40 min, and only about 5% boron is desorbed at this time, and the expected purpose is achieved. As the desorption process proceeds, at the end of the first stage, the boron desorption rate is only about 25%. In the second stage, lithium is substantially not desorbed, and boron is desorbed in a large quantity in this stage. At a desorption time of 300 min, boron is completely desorbed.

The above-described embodiments are merely preferred embodiments for the purpose of fully illustrating the present invention, and the scope of the present invention is not limited thereto. Equivalent substitutions or modifications can be made by those skilled in the art based on the present invention, which are within the scope of the present invention as defined by the claims. The scope of the present invention is defined by the appended claims.

1. A method for synchronously extracting lithium and boron resources in a boron-rich lithium-containing system, comprising steps of:
S1. filling Li/Al-LDHs as an adsorbent into an adsorption device to form an adsorption bed, pumping a boron-rich lithium-containing adsorption liquid from a lower end of the adsorption device, passing the boron-rich lithium-containing adsorption liquid through the adsorption bed, and then flowing the boron-rich lithium-containing adsorption liquid out from an upper end of the adsorption device;
S2. washing the adsorption bed with water from the upper end of the adsorption device after adsorption;
S3: pumping a boron desorbing liquid from the lower end of the adsorption device, passing the boron desorbing liquid through the adsorption bed, and collecting an effluent at the upper end of the adsorption device; and
S4. pumping a lithium desorbing liquid from the lower end of the adsorption device, passing the lithium desorbing liquid through the adsorption bed, and collecting an effluent at the upper end of the adsorption device.

2. A method for synchronously extracting lithium and boron resources in a boron-rich lithium-containing system, comprising steps of:
S1. filling Li/Al-LDHs as an adsorbent into an adsorption device to form an adsorption bed, pumping a boron-rich lithium-containing adsorption liquid from a lower end of the adsorption device, passing the boron-rich lithium-containing adsorption liquid through the adsorption bed, and then flowing the boron-rich lithium-containing adsorption liquid out from an upper end of the adsorption device;
S2. washing the adsorption bed with water from the upper end of the adsorption device after adsorption;
S3: pumping a lithium desorbing liquid from the lower end of the adsorption device, passing the lithium desorbing liquid through the adsorption bed, and collecting an effluent at the upper end of the adsorption device; and
S4. pumping a boron desorbing liquid from the lower end of the adsorption device, passing the boron desorbing liquid through the adsorption bed, and collecting an effluent at the upper end of the adsorption device.

3. The method for synchronously extracting lithium and boron resources in a boron-rich lithium-containing system according to claim 2, wherein in Step S1, the boron-rich lithium-containing adsorption liquid has a boron content of 1 to 5 g/L and a lithium content of 200 to 500 ppm.

4. The method for synchronously extracting lithium and boron resources in a boron-rich lithium-containing system according to claim 2, wherein in Step S1, the adsorption device is a fixed bed, and a feed flow rate of the boron-rich lithium-containing adsorption liquid is 1 to 4 BV/h.

5. The method for synchronously extracting lithium and boron resources in a boron-rich lithium-containing system according to claim 2, wherein in Step S2, the water is deionized water at 0 °C, a volume of the deionized water is 1 to 5 times a volume of the adsorption bed, and a flow rate of the deionized water is 5.5 to 50 mL/min.

6. The method for synchronously extracting lithium and boron resources in a boron-rich lithium-containing system according to claim 2, wherein the boron desorbing liquid has a chloride ion concentration of 2 to 5 M, a lithium ion concentration of 0 to 200 ppm, and a pH value of 2.5 to 6.

7. The method for synchronously extracting lithium and boron resources in a boron-rich lithium-containing system according to claim 6, wherein a desorption time with the boron desorbing liquid is 180 min.

8. The method for synchronously extracting lithium and boron resources in a boron-rich lithium-containing system according to claim 2, wherein:
the lithium desorbing liquid has a lithium ion concentration of 50 to 500 ppm and a pH value of 9 to 13; and
a temperature of the lithium desorbing liquid is 40 °C

9. The method for synchronously extracting lithium and boron resources in a boron-rich lithium-containing system according to claim 8, wherein a time for desorbing lithium with the lithium desorbing liquid is 180 min.

10. The method for synchronously extracting lithium and boron resources in a boron-rich lithium-containing system according to claim 2, wherein in Step S3 and S4, a flow rate of the boron desorbing liquid is 2-6 BV/h.

11. The method for synchronously extracting lithium and boron resources in a boron-rich lithium-containing system according to claim 1, wherein in Step S1, the boron-rich lithium-containing adsorption liquid has a boron content of 1 to 5 g/L and a lithium content of 200 to 500 ppm.

12. The method for synchronously extracting lithium and boron resources in a boron-rich lithium-containing system according to claim 1, wherein in Step S1, the adsorption device is a fixed bed, and a feed flow rate of the boron-rich lithium-containing adsorption liquid is 1 to 4 BV/h.

13. The method for synchronously extracting lithium and boron resources in a boron-rich lithium-containing system according to claim 1, wherein in Step S2, the water is deionized water at 0 °C, a volume of the deionized water is 1 to 5 times a volume of the adsorption bed, and a flow rate of the deionized water is 5.5 to 50 mL/min.

14. The method for synchronously extracting lithium and boron resources in a boron-rich lithium-containing system according to claim 1, wherein the boron desorbing liquid has a chloride ion concentration of 2 to 5 M, a lithium ion concentration of 0 to 200 ppm, and a pH value of 2.5 to 6.

15. The method for synchronously extracting lithium and boron resources in a boron-rich lithium-containing system according to claim 14, wherein a desorption time with the boron desorbing liquid is 180 min.

16. The method for synchronously extracting lithium and boron resources in a boron-rich lithium-containing system according to claim 1, wherein:
the lithium desorbing liquid has a lithium ion concentration of 50 to 500 ppm and a pH value of 9 to 13; and
a temperature of the lithium desorbing liquid is 40 °C

17. The method for synchronously extracting lithium and boron resources in a boron-rich lithium-containing system according to claim 16, wherein a time for desorbing lithium with the lithium desorbing liquid is 180 min.

18. The method for synchronously extracting lithium and boron resources in a boron-rich lithium-containing system according to claim 1, wherein in Step S3 and S4, a flow rate of the lithium desorbing liquid is 2-6 BV/h.
